(19) United States
(12) Patent Application Publication
(10) Pub. No.: US 2005/0237746 A1
(43) Pub. Date: Oct. 27, 2005

(54) Surface and recess mountable lighting fixture

(76) Inventor: Newman Lau Man Yiu, Kwai Chung (HK)

Correspondence Address: MERCHANT & GOULD PC, P.O. BOX 2903, MINNEAPOLIS, MN, 55402-0903, US

(21) Appl. No.: 10/831,941

(22) Filed: Apr. 26, 2004

(51) Int. Cl. F21V 29/00

(52) U.S. Cl. 362/294

(57) ABSTRACT

A lighting fixture having a housing mountable on surfaces and within recesses of a surface is disclosed. The housing further includes an open end and a bottom wall defining a plurality of openings. A side wall extends from the bottom wall and defines a plurality of slots. A reflector having a recessed area is received within the housing. The reflector defines a plurality of tabs extending from an edge of the reflector which are received by the slots in the side wall to secure the reflector within the housing. A lamp holder received in the housing engages a lamp bulb. A light cover received on the housing for closing the open end of the housing defines a plurality of openings for communicating air therethrough.

### BACKGROUND OF THE INVENTION

1. Field of the Invention

The present invention relates generally to a lighting fixture and, more particularly, to a lighting fixture mountable on surfaces and within recesses to provide bright light to surrounding surfaces.

2. Background

Lights and lighting fixtures are generally used to illuminate interior and exterior spaces in homes and buildings. However, some interior spaces within homes and buildings are too small to accommodate a conventional lighting fixture. For example, it is often desirable to illuminate surfaces under cabinets and shelves, but these areas often do not provide enough space to install a conventional lighting fixture. For such size-restricted areas, lighting fixtures, known as puck lights, are often mounted to a lower exterior surface or recessed therein, for providing lighting to surrounding areas. The puck lights thereby have a reduced profile outwardly of the mounting surface.

Many earlier puck lights were low-voltage lights, which generated little heat, but also did not provide sufficient illumination to surrounding surfaces. Thus, puck light systems utilizing high-voltage, 120 volt alternating current, were developed. The high-voltage puck light systems provided sufficient bright light, but the heat generated by the systems limited the application of the lights. For instance, the high-voltage puck lights typically required surface mounting and did not provide for mounting within recessed areas.

Accordingly, there is a need for a lighting fixture that can be mounted on a surface or within a recessed area that provides sufficient illumination while controlling the heat emitted by the lamps operating at high-voltage.

### SUMMARY OF THE INVENTION

The present invention relates to a lighting fixture mountable both to a surface and within a recess of a surface to provide bright light to the surrounding surfaces. One exemplary embodiment of the present invention comprises a housing having an open end and an opposing bottom wall. The bottom wall defines a plurality of openings for communicating air therethrough. A side wall extends upwardly from the bottom wall and defines a plurality of slots for engaging a reflector disposed within the housing of the lighting fixture. The reflector includes a plurality of tabs extending from an edge of the reflector which are received by the slots to secure the reflector within the housing. A lamp holder received in the housing engages a lamp bulb. A light cover received on the housing for closing the open end of the housing defines a plurality of openings for communicating air therethrough.

### BRIEF DESCRIPTION OF THE DRAWINGS

FIG. 1 is an exploded perspective view of a lighting fixture according to the present invention;

FIG. 2A is a side view of the housing and the insulating attachment of the lighting fixture shown in FIG. 1, in an installed position;

FIG. 2B is a side view of the housing and the insulating attachment of the lighting fixture shown in FIG. 1, in an uninstalled position;

FIG. 3 is a bottom view of the housing of the lighting fixture shown in FIG. 1;

FIG. 4 is a perspective view of a surface-mounting installation of the lighting fixture shown in FIG. 1;

FIG. 5 is a perspective view of a recessed-mounting installation of the lighting fixture shown in FIG. 1.

### DETAILED DESCRIPTION OF THE PREFERRED EMBODIMENT

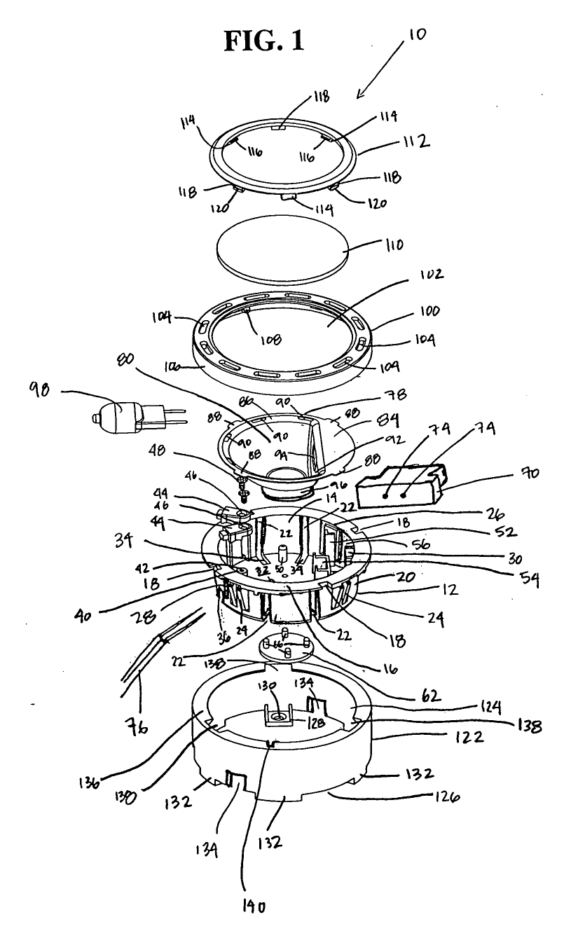

Referring now to the drawings in which like parts have like numerals, FIG. 1 illustrates a lighting fixture 10 of the present invention. As discussed herein, the lighting fixture 10 of the present invention is adapted for mounting to a surface or within a recessed area of a surface. The lighting fixture 10 comprises a housing 12 having an open end 14 with a flange 16, extending laterally therefrom, and an opposing bottom wall 32. The open end 14 and the bottom wall 32 are spaced apart from one another by a side wall 20. Two pairs of opposing notches 18 are defined in the flange 16, for a purpose discussed below. The side wall 20 defines a plurality of openings 22 extending from the open end 14 to the bottom wall 32 of the lighting fixture 10. The openings 22 provide pathways for communicating air therethrough. The side wall 20 includes two pairs of opposing tabs 24 integrally formed at a first end with the housing 12 for providing flexible movement relative to the side wall of the housing. Above the tabs 24 and adjacent the open end 14 of the housing 12, the side wall 20 defines slots 26, for a purpose discussed below. Further, the side wall 20 defines a flange 28 extending outwardly from the side wall.

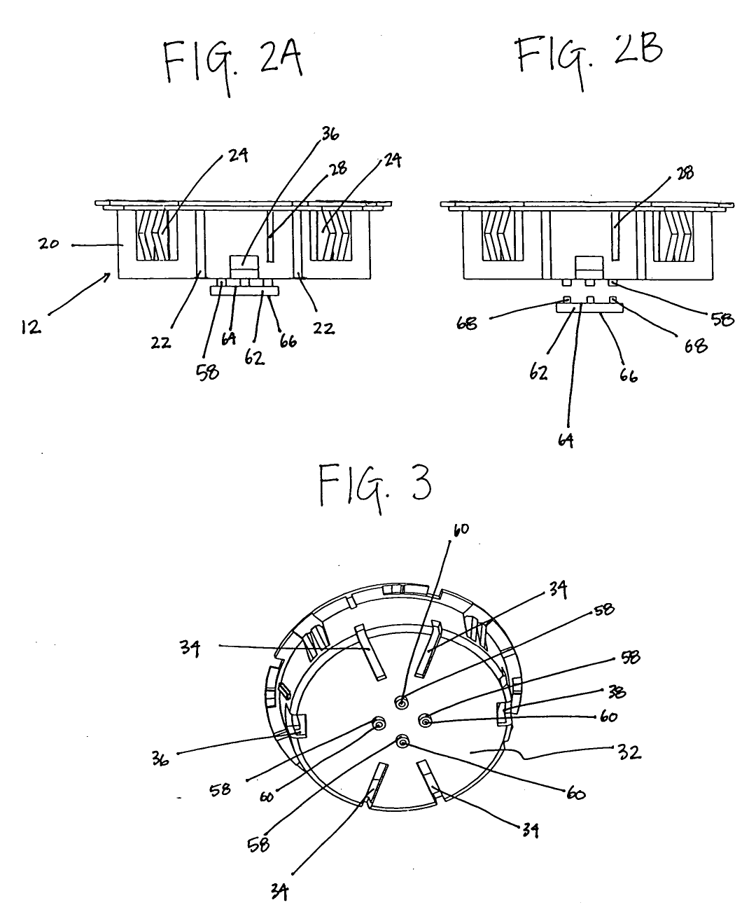

The bottom wall 32 defines a plurality of openings 34 for providing pathways to communicate air therethrough, as illustrated in FIGS. 1 and 3. In the illustrated embodiment, the openings 34 are arranged adjacent the openings 22 of the side wall 20. The side wall 20 and the bottom wall 32 define a first slot 36 and an opposing second slot 38, as illustrated in FIG. 3, for receiving a pair of electric wires 76. A pair of posts 40, disposed on opposing sides of the first slot 36, extend upwardly from an upper side of the bottom wall 32. Each of the posts 40 defines a bore 42 extending along a longitudinal axis of each post. A pair of supports 44, each defining a hole 46 at the distal end of the support, are connected to the posts 40 by fasteners 48 inserted through the holes and bores. The supports 44 secure the electric wires 76 in the first slot 36 and provide strain relief from forces asserted on the electric wires. A pair of opposing studs 50 extend upwardly from the upper side of the bottom wall 32 and guide the electric wires 76 within the housing 12.

A pair of flanges 30, arranged on opposing sides of the second slot, extend laterally from the side wall 20. Spaced apart from the flanges 30 are a pair of V-shaped flanges 52 extending upwardly from the upper side of the bottom wall 32. An E-shaped flange 54 extends upwardly from the upper side of the bottom wall 32. The E-shaped flange 54 is disposed inwardly from the side wall 20 between the pair of V-shaped flanges 52. The flanges 30, V-shaped flanges 52, and E-shaped flange 54 together define a rest 56 for receiving a lamp holder 70. The flanges 30, V-shaped flanges 52, and E-shaped flange 54 also guide the electric wires 76 through the housing 12 and the second slot. The lamp holder 70 defines back openings for receiving the ends of the electric wires 76 and defines front openings, or sockets, 74 for engaging a lamp bulb 98.

The bottom wall 32 defines a plurality of posts 58 arranged around a central portion of the bottom wall 32, as shown in FIG. 3. Each post 58 extends downwardly from a lower side of the bottom wall 32 and defines a bore 60 extending along a longitudinal axis of each post and through the bottom wall for receiving an insulating attachment 62 having an interior side 64 and an exterior side 66, as illustrated in FIGS. 2A-2B. FIG. 2A illustrates the housing 12 and insulating attachment 62 in an installed position, and FIG. 2B illustrates the housing and insulating attachment in an uninstalled position. Extending upwardly from the interior side 64 of the insulating attachment 62 are a plurality of studs 68. The bores 60 defined by the posts 58 are configured for receiving therethrough the studs 68. When the insulating attachment 62 is in an installed position, as shown by FIG. 2A, the insulating attachment is spaced apart from the lower side of the bottom wall 32 by the posts 58 which defines a gap between the insulating attachment and the bottom wall. This gap provides a pathway for communicating air therethrough.

The lighting fixture 10 includes a reflector 78 received within the housing 12. The reflector 78 preferably is an aluminum member including a recessed area 80 and a flat portion 84, both encompassed by a laterally extending flange 86. The recessed area 80 and the flat portion 84 are connected together by a side surface 92 extending from the recessed area to the flat portion. As illustrated in FIG. 1, the face of the recessed area 80 may include plurality of facets for reflecting light. The flange 86 includes a plurality of tabs 88 extending laterally from an edge of the flange. The slots 26 of the side wall 20 receive the tabs 88 of the flange 86 to securely attach the reflector 78 within the housing 12. When the reflector 78 is attached within the housing 12, the edge of the flange 86 is adjacent the side wall 20, and the flat portion 84 of the reflector 78 is disposed above the lamp holder 70. The side surface 92 defines an elongated opening 84 to provide access to the sockets 74 of the lamp holder 70 for engaging the lamp bulb 98 to the lamp holder when the reflector 78 is attached within the housing 12. A pad 96 of insulative material is disposed between the reflector 78 and the central portion of the bottom wall 32. The flange defines a plurality of openings 90 at an edge of the recessed area 80. The openings 90 provide a pathway to communicate air therethrough.

A light cover 100 closes the open end 14 of the housing 12. The light cover 100 defines a concentric opening 102 for receiving a lens 110 therein. The lens 110 is preferably made from a transparent material such as plastic or glass. As illustrated in FIG. 1, the lens 110 includes a holder 112 extending around an edge of the lens for securing the lens within the concentric opening 102 of the light cover 100. Extending downwardly from an edge of the holder 112 are a plurality of tabs 114, each having a hook 116, at the distal end of the tab, angled inwardly for cooperatively engaging the lens 110. Extending downwardly from an edge of the holder 112 and off-set from the tabs 114 are a plurality of tabs 118, each having a hook 120, at the distal end of the tab, angled outwardly for cooperatively engaging the light cover 100. The light cover 100 defines a plurality of openings 104 for providing a pathway to communicate air therethrough. Two pairs of opposing tabs 108 extend radially inward from a skirt 106 of the light cover 100. When the light cover 100 engages the housing 12 to close the open end 14 of the housing, each of the tabs 108 aligns with each of the notches 18 defined by the flange 16. Rotation of the light cover 100 brings the tabs 108 under the flange 16 to secure the light cover to the housing 12.

The lighting fixture 10 described above is useful when recessing mounting. For surface mounting the lighting fixture, FIG. 1 also illustrates a collar 122 having two opposing ends 124, 126 and a flange 136 extending inwardly from the first end 124 of the collar. The flange 136 defines a plurality of notches 138 spaced apart around the flange. The flange 136 further defines an indentation 140, which aligns with the flange 28 of the side wall 20, for a purpose discussed below. A plurality of connectors 128 extend inwardly from the opposing end 126 of the collar 122. Each connector 128 defines an opening 130. The notches 138 align with the openings 130 in the connectors 128 to provide access to the openings. Off-set from the connectors 128 are a plurality of tabs 132 extending downwardly from the opposing end 126 of the collar 122 for spacing the collar from a surface to which the collar mounts and for providing a pathway to communicate air therethrough. Further, the opposing end 126 of the collar 122 defines a pair of opposing notches 134, which align with the first slot 36 and second slot defined by the side wall 20 and bottom wall 32 of the housing 12, to receive the electric wires 76 therein.

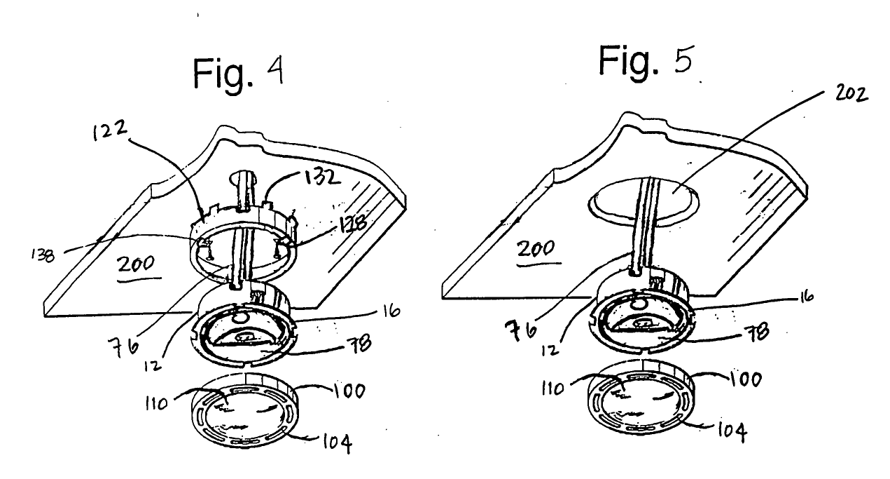

The lighting fixture 100 of the present invention mounts to the surface 200, as illustrated in FIG. 4. The electric wires 76 are passed through the collar 122 and extended through a hole in the surface 200. The electric wires 122 are connected to a source of voltage. The collar 122 is mounted to the surface 200 with screws extending through the openings 130 defined by the plurality of connectors 128. The flange 28 extending outwardly from the side wall 20 is then aligned with the indentation 140 of the flange 136 of the collar 122 to engage the housing 12, having the reflector 78 disposed therein, with the collar. The housing 12 is pushed into the collar 122. The two pairs of opposing tabs 24 flex and allow the housing 12 to pass by the flange 136. The light cover 100 is attached as described above. The plurality of tabs 132 extending downwardly from the opposing end 126 of the collar 122 provide a pathway for air to flow between the lighting fixture 10 and the surface 100.

As illustrated in FIG. 5, the lighting fixture 10 also mounts within a recess 202 of a surface 200. An appropriate sized hole is created in the surface 200, and the housing 12 of the lighting fixture 10, including the reflector 78, is inserted within the hole. The electrical wires 76 are passed through the hole and connected to a source of voltage. The flange 16 overlaps a portion of the surface 200. The light cover 100 is attached to the open end 14 of the housing 12 by aligning the tabs 108 with the notches 18 defined in the flange 16 and then rotating the light cover 100 to bring the tabs under the flange.

The configuration of the lighting fixture 10 of the present invention defines pathways for communicating heat generated by the lighting fixture to ambient air. Air enters the lighting fixture 10 through the plurality of openings 104 in the light cover 100 and flows through the plurality of openings 90 in the flange 86 of the reflector 78. When the lamp bulb 98 is illuminated, the air flowing past the reflector 78 becomes heated. The heated air exits the housing 12 through the openings 22, 34 in the side wall 20 and the bottom wall 32, respectively. Further, the gap defined by the insulating attachment 62 and the bottom wall 32 provides a pathway for ambient air to flow through.

Although the present invention has been described with reference to specific details of certain embodiments thereof, it is not intended that such details should be regarded as limitations upon the scope of the invention except as and to the extent that they are included in the accompanying claims.

1. A light fixture, comprising:
a housing comprising:
an open end;
a bottom wall opposing the open end, the bottom wall defining a plurality of openings for communicating air therethrough; and
a side wall extending upwardly from the bottom wall, the side wall defining a plurality of slots adjacent the open end;
a reflector disposed in the housing, the reflector having a recessed area, and a plurality of tabs extending from an edge of the reflector, the plurality of tabs adapted to engage the plurality of slots of the side wall;
a lamp holder disposed in the housing, the lamp holder adapted to electrically couple with a lamp bulb; and
a light cover disposed on the housing, the light cover defining a plurality of openings for communicating air therethrough.

2. The lighting fixture of claim 1, wherein the housing further comprises an insulating attachment disposed on a lower side of the bottom wall when in an installed position, the insulating attachment adapted to removably couple with the lower side of the bottom wall.

3. The lighting fixture of claim 2, wherein the insulating attachment further comprises an interior side and an exterior side, the interior side having at least one projection extending upwardly from the interior side and adapted to removably couple with the lower side of the bottom wall.

4. The lighting fixture of claim 3, wherein the bottom wall of the housing further comprises at least one mounting portion extending downwardly from the lower side, the at least one mounting portion adapted to removably engage the at least one projection of the insulating attachment.

5. The lighting fixture of claim 1, further comprising an insulating pad disposed in the housing, the insulating pad having two opposed sides.

6. The lighting fixture of claim 5, wherein one side of the insulating pad is disposed adjacent the reflector, and the opposed side is disposed adjacent an upper side of the bottom wall.

7. The lighting fixture of claim 1, wherein the side wall further defines a plurality of openings extending from the open end to the bottom wall of the housing, the plurality of openings for communicating air therethrough.

8. The lighting fixture of claim 1, further comprising a collar for receiving the housing, the collar having a plurality of tabs extending outwardly from the collar for defining a gap between the collar and a surface to which the collar is mounted.

9. The lighting fixture of claim 1, further comprising a rest portion disposed in the housing and adapted to receive the light holder.

10. The lighting fixture of claim 1, wherein the reflector further defines an opening adjacent the light holder, the opening adapted to provide access to the light holder for engaging the lamp bulb to the light holder.

11. The lighting fixture of claim 1, wherein the light cover further defines a concentric opening adapted to receive a transparent lens therein.

12. A lighting fixture, comprising:
a housing comprising:
an open end;
a bottom wall opposing the open end, the bottom wall defining a plurality of openings for communicating air therethrough; and
a side wall extending upwardly from the bottom wall, the side wall defining a plurality of slots adjacent the open end, and a plurality of openings extending from the open end to the bottom wall of the housing, the plurality of openings for communicating air therethrough;
a reflector disposed in the housing, the reflector having a recessed area, and a plurality of tabs extending from an edge of the reflector, the plurality of tabs adapted to engage the plurality of slots of the side wall;
a lamp holder disposed in the housing;
a lamp bulb disposed in the housing, the lamp bulb adapted to electrically couple with the lamp holder;
a light cover disposed on the housing, the light cover defining a plurality of openings for communicating air therethrough, and a concentric opening adapted to receive a transparent lens therein; and
electrical wires connected to the lamp holder, the electrical wires for providing current to the lamp bulb for lighting the lamp bulb.

13. The lighting fixture of claim 12, wherein the housing further comprises an insulating attachment disposed on a lower side of the bottom wall when in an installed position, the insulating attachment adapted to removably couple with the lower side of the bottom wall.

14. The lighting fixture of claim 13, wherein the insulating attachment further comprises an interior side and an exterior side, the interior side having at least one projection extending upwardly from the interior side and adapted to removably couple with the lower side of the bottom wall.

15. The lighting fixture of claim 14, wherein the bottom wall of the housing further comprises at least one mounting portion extending downwardly from the lower side, the at least one mounting portion adapted to removably engage the at least one projection of the insulating attachment.

16. The lighting fixture of claim 12, further comprising an insulating pad disposed in the housing, the insulating pad having two opposed sides.

17. The lighting fixture of claim 16, wherein one side of the insulating pad is disposed adjacent the reflector, and the opposed side is disposed adjacent an upper side of the bottom wall.

18. A lighting fixture, comprising:
a housing comprising:
an open end;
a bottom wall opposing the open end, the bottom wall defining a plurality of openings for communicating air therethrough;
a side wall extending upwardly from the bottom wall, the side wall defining a plurality of slots adjacent the open end, and a plurality of openings extending from the open end to the bottom wall of the housing, the plurality of openings for communicating air therethrough; and
an insulating attachment disposed on a lower side of the bottom wall when in an installed position, the insulating attachment adapted to removably couple with the lower side of the bottom wall;
a reflector disposed in the housing, the reflector having a recessed area, and a plurality of tabs extending from an edge of the reflector, the plurality of tabs adapted to engage the plurality of slots of the side wall;
a lamp holder disposed in the housing;
a lamp bulb disposed in the housing, the lamp bulb adapted to electrically couple with the lamp holder;
a light cover disposed on the housing, the light cover defining a plurality of openings for communicating air therethrough, and a concentric opening adapted to receive a transparent lens therein; and
electrical wires connected to the lamp holder, the electrical wires for providing current to the lamp bulb for lighting the lamp bulb.

19. The lighting fixture of claim 18, wherein the insulating attachment further comprises an interior side and an exterior side, the interior side having at least one projection extending upwardly from the interior side and adapted to removably couple with the lower side of the bottom wall.

20. The lighting fixture of claim 19, wherein the bottom wall of the housing further comprises at least one mounting portion extending downwardly from the lower side, the at least one mounting portion adapted to removably engage the at least one projection of the insulating attachment.

21. The lighting fixture of claim 18, further comprising an insulating pad disposed in the housing, the insulating pad having two opposed sides.

22. The lighting fixture of claim 21, wherein one side of the insulating pad is disposed adjacent the reflector, and the opposed side is disposed adjacent an upper side of the bottom wall.

23. The lighting fixture of claim 18, further comprising a collar for receiving the housing, the collar having a plurality of tabs extending outwardly from the collar for defining gap between the collar and a surface to which the collar is mounted.

24. The lighting fixture of claim 18, further comprising a rest portion disposed in the housing and adapted to receive the light holder.

25. The lighting fixture of claim 18, wherein the reflector further defines an opening adjacent the light holder, the opening adapted to provide access to the light holder for engaging the lamp bulb to the light holder.
